(19) United States
(12) Patent Application Publication
(10) Pub. No.: US 2025/0268116 A1
(43) Pub. Date: Aug. 28, 2025

(54) TRACTOR

(71) Applicant: CLAAS Tractor SAS, VéIizy-VilIacoubIay Cedex (FR)

(72) Inventors: Andreas Krawinkel, Paderborn (DE); Paul Henri Guitton, Plaisir (FR); Aurelien Volck, Limersheim (FR)

(73) Assignee: CLAAS Tractor SAS, VéIizy-VilIacoubIay Cedex (FR)

(21) Appl. No.: 19/066,530

(22) Filed: Feb. 28, 2025

(30) Foreign Application Priority Data
Feb. 28, 2024 (DE) 10 2024 105 598.7

(51) Int. Cl. A01B 51/02; B60G 3/20; B60G 7/00; B60K 11/04; B60K 17/02; B60K 17/04; B60K 17/28; B60K 17/34; B62D 7/16; B62D 49/08

(52) U.S. Cl. CPC A01B 51/026; B60G 3/20; B60G 7/001; B60K 11/04; B60K 17/02; B60K 17/04; B60K 17/28; B60K 17/34; B62D 7/163; B62D 49/085; B60G 2200/144; B60G 2206/124; B60G 2300/082

(57) ABSTRACT

A tractor with a chassis comprising a drive unit, a drive gear, a drivable rear axle assembly, a front axle assembly and a front attachment assembly. The front axle assembly comprises an axle drive housing and two wheel suspensions mounted thereon, on which front ground engagement means is positioned. The tractor further comprises a cooling system for cooling the drive unit. The axle drive housing is arranged between the drive unit and the front attachment assembly viewed in the longitudinal direction of the tractor. The cooling system is arranged above the axle drive housing and, viewed in the longitudinal direction of the vehicle, completely between a front, vertically extending plane tangent to the envelope curves of the front ground engagement means in the straight-ahead position, and a rear, vertically extending plane which is tangent to the envelope curves of the front ground engagement means in the straight-ahead position.

### CROSS REFERENCE TO RELATED APPLICATION

This application claims priority under 35 U.S.C. § 119 to German Patent Application No. DE 10 2024 105 598.7 filed Feb. 28, 2024, the entire disclosure of which is hereby incorporated by reference herein.

### TECHNICAL FIELD

The present invention relates to a camera tractor.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Axle assemblies are components used in agricultural work machines, such as tractors. A front axle assembly, in addition to a front axle with steerable front wheels arranged or positioned thereon, usually comprises, for example, a front axle support, which may be mounted on the front axle to support it, and a chassis of the agricultural work machine. The overall front axle assembly is thereby movable relative to the chassis and may therefore adapt to uneven ground without the chassis of the work machine having to follow every movement of the front axle, such as during steering movements of the front wheels. A drive shaft, which transmits a torque from a drive motor to such a front axle, may also be designed to be movable in order to be able to follow the movements of the front axle assembly.

Planting, cultivating and many other common farming practices necessitate extreme precision in maneuverability. Driving around obstacles and cultivating narrow row crops also requires excellent maneuverability, which may mean that agricultural work machines often have to meet high demands in terms of maneuverability. In addition, a small turning circle at the headland of a field saves time and space. These requirements of extreme precision and excellent maneuverability may often be associated with a high power requirement of the work machines, which leads to an increased installation space requirement which in turn may negatively influence the steering and therefore the maneuverability of the work machine. A higher power requirement may also require larger front wheels which further increases the challenges in terms of maneuverability. The challenges are further exacerbated by the fact that narrow and adjustable tire spacing and dual tires are often used.

In order to address these challenges, U.S. Pat. No. 5,152,364 discloses an architecture of a tractor in such a way that the drive unit (e.g., the engine) of the tractor is arranged directly above the front axle, and the cooling system is positioned far enough in front of the drive unit so that even large wheels lying close to each other may turn into the space between the cooling system and the drive unit. This configuration extends the front part of the tractor so that it protrudes well beyond the front axle.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic and exemplary representation of a tractor.

FIG. 2 illustrates a schematic and exemplary representation of a chassis of the tractor according to FIG. 1.

FIG. 3 illustrates a schematic and exemplary representation of a front of the tractor according to FIG. 1 with an open engine hood.

FIG. 4 illustrates a schematic and exemplary representation of a front axle assembly of the chassis according to FIG. 2 in a first view.

FIG. 5 illustrates a schematic and exemplary representation of a front axle assembly from FIG. 4 in a second view.

FIG. 6 illustrates the connection between the drive unit and the drive gear.

FIG. 7 illustrates an expanded block diagram of the axle drive housing.

FIG. 8 illustrates an expanded block diagram of the rear axle assembly.

### DETAILED DESCRIPTION

As discussed in the background, a vehicle, such as a tractor, may be configured for extreme precision and excellent maneuverability. Separation of the cooling system and drive unit may therefore makes it possible to create a space into which the front wheels may turn when turning, but may create disadvantages with regard to the cooling itself, the tractor's center of gravity and, as a result, the ballasting of the tractor and the coupling of the tractor to attachments. The high position of the drive unit above the front axle may also require an additional cardan shaft and/or gear stage to connect the drive unit to the drive gear.

Based on this, it may be an object of the present invention to eliminate or reduce the described disadvantages of the prior art and, in particular, to present a tractor which improves maneuverability with high power requirements and a wide variety of configurations of front ground engagement means, without spatial separation of the cooling system and drive unit.

Accordingly, in one or some embodiments, a tractor is disclosed. The tractor includes a chassis that comprises a drive unit, a drive gear, a drivable rear axle assembly with rear ground engagement means arranged or positioned thereon, a front axle assembly with front ground engagement means arranged or positioned thereon, and a front attachment assembly for coupling attachments or for receiving ballast weights. The front axle assembly may comprise an axle drive housing and at least two wheel suspensions (such as only two wheel suspensions) mounted opposite each other on the axle drive housing, on which the front ground engagement means are arranged or positioned. The tractor may further comprise a cooling system configured to cool the drive unit. The axle drive housing of the front axle assembly may be arranged or positioned between the drive unit and the front attachment assembly viewed in the longitudinal direction of the vehicle. The cooling system may be arranged or positioned above the axle drive housing and, viewed in the longitudinal direction of the vehicle, completely between a front, vertically extending plane which is tangent to the envelope curves of the front ground engagement means in the straight-ahead position, and a rear, vertically extending plane which is tangent to the envelope curves of the front ground engagement means in the straight-ahead position.

The creation of an integrated front axle by arranging the axle drive housing of the front axle assembly and therefore the front axle assembly as a whole between the drive unit and the front attachment assembly may ensure that the front attachment assembly and the drive unit are largely displaced from the radius of action of the front ground engagement means by sufficient spacing. In other words, the front attachment assembly and the drive unit may create basically no restrictions on the freedom of movement of the front ground engagement means arranged or positioned above the wheel suspensions in all vehicle directions. Due to the integration of the front axle assembly, installation space may also be created above the front axle assembly itself, which may be used to accommodate the cooling system. The specific arrangement of the cooling system between the two vertically extending planes tangent to the envelope curves of the front ground engagement means in the straight-ahead position may ensure that the cooling system is also largely shifted out of the radius of action of the front ground engagement means and therefore also basically does not create any restrictions on the freedom of movement of the front ground engagement means in one, some or all vehicle directions. Rather, the cooling system is positioned above the front axle assembly in an area between the front ground engagement means into which the front ground engagement means do not penetrate even at a maximum turn. This design may ensure that the front ground engagement means may, on the one hand, be positioned closer than usual relative to the chassis, while the maximum possible steering angle of the front ground engagement means is still sufficiently large despite everything to ensure good maneuverability (e.g., the smallest possible turning radius and maneuverability of the tractor). In particular, such configuration may be use when working in row crops, which may require high precision with regard to steering and directional stability and in which the tractor is often equipped with double tires with small track widths.

In one or some embodiments, one, some, or each of the axle drive housing, the drive unit and the front attachment assembly may comprise at least two connection interfaces spaced apart from one another in the longitudinal direction of the vehicle, wherein the axle drive housing and the drive unit may each be connected to one another by means of one of their two connection interfaces, and/or wherein the axle gear housing and the front attachment assembly may each be connected to one another by means of one of their two connection interfaces, and/or wherein the drive unit is connected to the drive gear by means of one of its two connection interfaces, and/or wherein the front attachment assembly is configured to couple attachments or to accommodate ballast weights by means of one of its two connection interfaces.

In one or some embodiments, one, some or each of the axle drive housing, the drive unit and the front attachment assembly therefore may comprise a front connection interface, (e.g., a connection interface that faces the front of the tractor) and a rear connection interface (e.g., a connection interface that faces the rear of the tractor). The front connection interface and the rear connection interface may be spaced apart from each other in the longitudinal direction of the vehicle. The rear connection interface of the axle drive housing may be connected to the front connection interface of the drive unit. The front connection interface of the axle drive housing may be connected to the rear connection interface of the front attachment assembly. The drive unit may also be connected to the drive gear via its rear connection interface, and the front attachment assembly may be configured to couple one or more attachments or to accommodate ballast weights via its front connection interface.

In one or some embodiments, the cooling system is arranged or positioned completely between the two connection interfaces (e.g., the front connection interface and the rear connection interface) of the axle drive housing viewed in the longitudinal direction of the vehicle.

The positioning of the cooling system between the front and rear connection interfaces of the axle drive housing of the front axle assembly may ensure that the cooling system is arranged or positioned directly above the axle drive housing (e.g., in the center of the front axle assembly). There may be sufficient space in the center of the front axle assembly between the front ground engagement means, which may be advantageously used for the arrangement of components with a high installation space requirement, such as the cooling system with its various units. Since this “central” area basically coincides with the position of the wheel suspensions viewed in the longitudinal direction of the vehicle, it is basically outside the radius of action of the front ground engagement means. Movements of the front ground engagement means, such as while making turns, therefore may only affect this area to a negligible extent, if at all.

In one or some embodiments, the drive unit in an area upstream from the connection interface by means of which the drive unit is connected to the axle drive housing (e.g., its front connection interface) and the front attachment assembly in an area downstream from its connection interface through which the front attachment assembly is connected to the axle drive housing (e.g., its rear connection interface) each include an indentation or a recess (e.g., a respective recess for the drive unit and a respective recess for the front attachment assembly).

The creation of respective indentations or recesses in the areas adjacent to the axle drive housing of the components adjacent to the front axle assembly (e.g., the drive unit and the front attachment assembly) may further enhance the high maneuverability of the tractor. Specifically, when the front ground engagement means are turned, the front ground engagement means may move into the respective indentations or recesses, and the maximum steering angle of the front ground engagement means may therefore be further increased in comparison to a design without such indentations or recesses. In addition, this design may allow the front ground engagement means to be arranged or positioned closer to the chassis, which may make the tractor narrower overall in the front area.

In one or some embodiments, the drive unit is designed as an internal combustion engine with an engine block and an oil pan arranged or positioned below the engine block, wherein the oil pan that comprises the two connection interfaces (e.g., the front connection interface and the rear connection interface) of the drive unit. The drive unit may therefore be a structural component of the tractor.

In one or some embodiments, each wheel suspension of the front axle assembly comprises an upper wishbone and a lower wishbone, each of which may be pivotably connected on the one hand to the axle drive housing and on the other hand to a wheel hub, on each of which at least one front ground engagement means may be rotatably mounted.

The use of wheel suspensions with two wishbones may ensure a high freedom of movement and therefore a large radius of action for the front ground engagement means in one, some or all vehicle directions. Even large differences in height of the ground on which the tractor moves during operation may be compensated for in a comfortable way.

In one or some embodiments, each wheel suspension of the front axle assembly comprises a steering rod which is coupled on the one hand to the wheel hub and on the other hand, such as with the interposition of a steering cylinder, to a steering gear arranged or positioned in the axle drive housing.

In one or some embodiments, viewed in the longitudinal direction of the vehicle, the steering rod is positioned closer to the connection interface of the axle drive housing by means of which the axle drive housing is connected to the drive unit (e.g. the rear connection interface) than to the connection interface of the axle drive housing by means of which the axle drive housing is connected to the front attachment assembly (e.g., the front connection interface).

In one or some embodiments, viewed in the longitudinal direction of the vehicle, the steering rod is arranged or positioned behind an axle running centrally through the wheel hubs of the wheel suspension in the width direction of the vehicle.

Coupling the steering gear and wheel hub via a steering rod positioned in this way may create very precise steering of the tractor with particularly good response behavior. This may allow the tractor to be maneuvered very precisely on the road, on a farmyard or in the field, wherein at the same time the operator receives meaningful feedback from the steering. In addition, such positioning may allow higher steering angles with small track widths of the front ground engagement means.

In one or some embodiments, the upper wishbone and/or the lower wishbone of each wheel suspension of the front axle assembly is coupled to the axle drive housing by means of at least one suspension and/or damping element.

The coupling of the front ground engagement means to the chassis via suspended and/or damped wishbones relative to the axle drive housing may ensure very highly perceptible driving comfort with good directional stability at the same time.

In one or some embodiments, the upper wishbone and/or the lower wishbone of each wheel suspension of the front axle assembly is Y-shaped, wherein the wishbone is pivotably connected to the axle drive housing by means of two connection points and rotatably connected to the wheel hub by means of one connection point.

This design of the wishbones may ensure a reliable transmission of force of the forces acting via the front ground engagement means to the chassis, and at the same time may ensure that the front ground engagement means are able to reproduce a large steering angle.

In one or some embodiments, the drive unit comprises an output shaft, wherein the output shaft may be coupled to an input shaft of the drive gear and may be aligned therewith.

The aligned position of the output shaft of the drive unit and the input shaft of the drive gear may ensure that the chassis is essentially at the same distance from the ground along the entire length viewed in the longitudinal direction of the vehicle, which may ensure good ground clearance.

In one or some embodiments, the drive unit comprises an output shaft, wherein the output shaft may be coupled to a power take-off shaft mounted in the front attachment assembly, such as with the interposition of a power take-off shaft gearbox arranged or positioned in the front attachment assembly, and a shaft.

In one or some embodiments, the PTO shaft is arranged or positioned completely in front of the front, vertically extending plane which is tangent to the envelope curves of the front ground engagement means in the straight-ahead position, viewed in the longitudinal direction of the vehicle.

The arrangement of the PTO shaft in the longitudinal direction of the vehicle in front of the front, vertically extending plane may ensure that the PTO shaft and therefore the attachments that may be coupled thereby do not have a detrimental effect on the radius of action of the front ground engaging tools and therefore the maneuverability of the tractor.

In one or some embodiments, the drive unit comprises an output shaft, wherein the output shaft may be coupled to a drive gear arranged or positioned in the axle drive housing for driving the front ground engagement means.

The possibility of coupling an output shaft to a drive gear arranged or positioned in the axle drive housing may make it possible to realize different driving modes, such as any one, any combination, or all of a pure rear-wheel drive, a pure ground engaging drive, or an all-wheel drive.

In one or some embodiments, auxiliary units are assigned to the drive unit, wherein the auxiliary units are arranged or positioned completely above an upper, horizontally extending plane which may be tangent to the envelope curve of the front ground engagement means in the straight-ahead position viewed in the vehicle height direction.

Such an arrangement of the auxiliary units of the drive unit may ensure that these components also do not adversely influence the radius of action of the front ground engagement means, which may further enhance the maneuverability of the tractor.

In one or some embodiments, the cooling system may comprise at least one fan, at least one oil cooler and at least one heat exchanger, which may be arranged or positioned adjacent to one another viewed in the longitudinal direction of the vehicle.

In one or some embodiments, at least one of the at least one fan, the at least one oil cooler and the at least one heat exchanger of the cooling system is arranged or positioned inclined with respect to the longitudinal direction of the vehicle and the vertical direction of the vehicle.

The inclined arrangement of at least one unit of the cooling system may ensure a more efficient use of installation space and therefore a more compact arrangement of the cooling system as a whole.

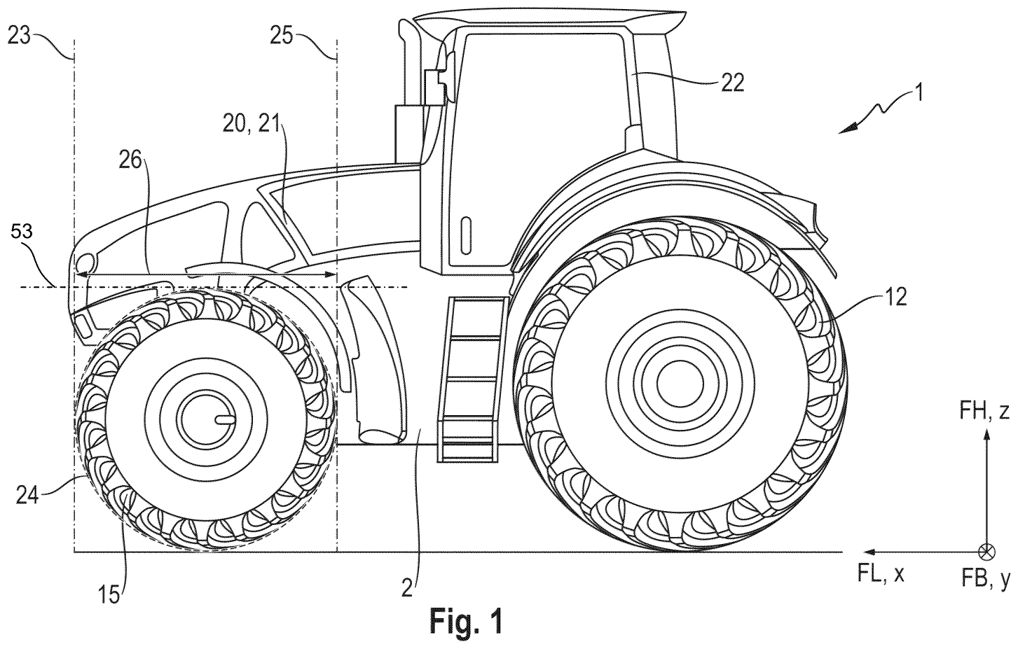

Referring to the figures, FIG. 1 illustrates a tractor 1, wherein the basic structure of a tractor 1. Example tractors are disclosed in US Patent Application Publication No. 2022/0000006 A1, US Patent Application Publication No. 2022/0001739A1; US Patent Application Publication No. 2025/0057068 A1, each of which are incorporated by reference herein in their entirety. The tractor 1 may be spatially defined on the basis of three directions of extension, which are indicated by way of example by a coordinate system in FIG. 1. The first direction of extension is the longitudinal direction of the tractor 1, hereinafter also referred to as the vehicle longitudinal direction FL running in the x-axis direction, the second direction of extension is the width direction of the tractor 1, hereinafter also referred to as the vehicle width direction F_{B} which runs in the y-axis direction, and the third direction of extension is the height (or vertical) direction of the tractor 1, hereinafter also referred to as a height direction of the vehicle F_{H} (or the vertical direction of the vehicle) which runs in the z-axis direction.

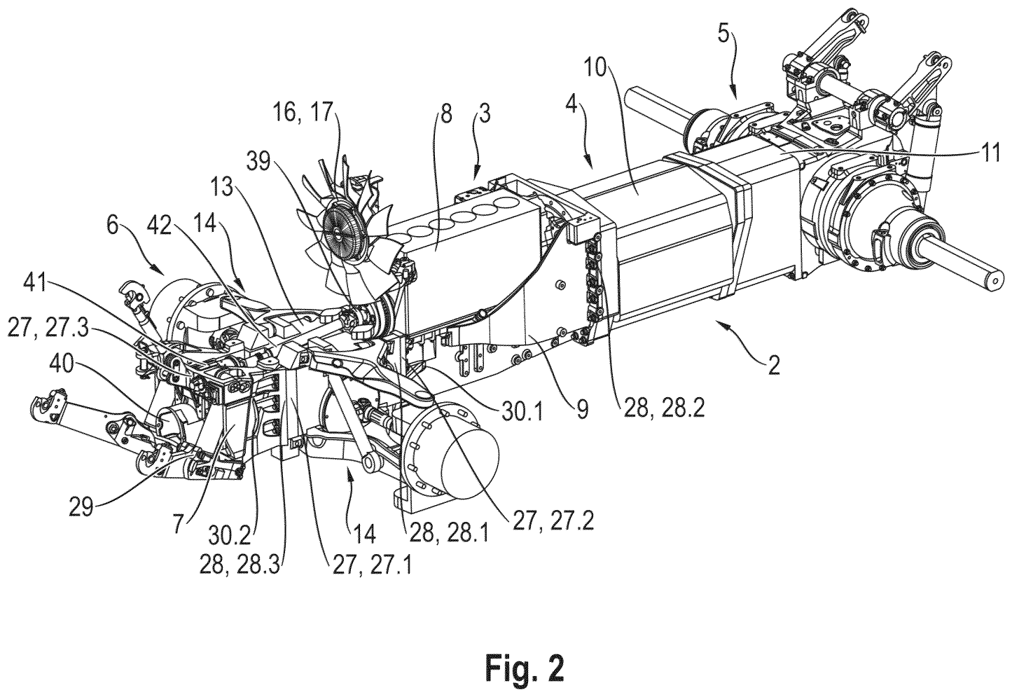

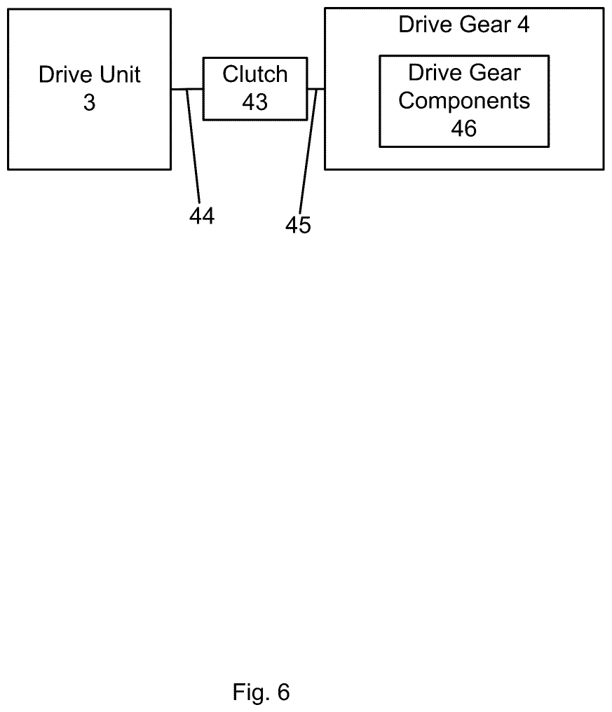

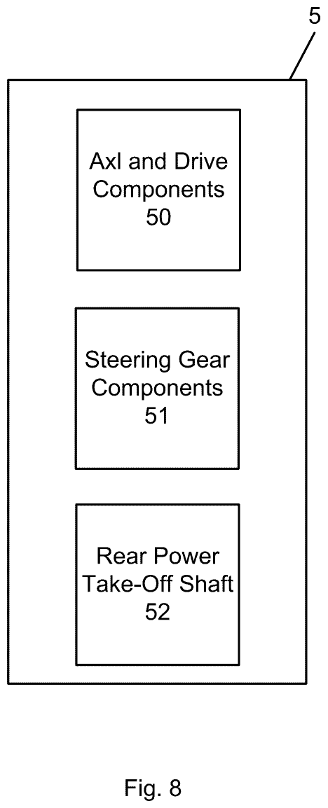

The tractor 1 comprises, among other things, a chassis 2 which is shown schematically and as an example in FIG. 2. The chassis 2 may be formed by any one, any combination, or all of: a drive unit 3; a drive gear 4; a rear axle assembly 5; a front axle assembly 6 and a front attachment assembly 7 for coupling attachments or for holding ballast weights. The tractor 1 may therefore be a tractor of block construction in which the aforementioned components of the drive unit 3, the drive gear 4, the rear axle assembly 5, the front axle assembly 6, and the front attachment assembly 7 form the bearing structure of the tractor 1 so that no separate support frame may be required. Viewed in the longitudinal direction of the vehicle F_{L}, the rear axle assembly 5 may form the rear component of the chassis 2, and the front attachment assembly may form the front component of the chassis 2. Viewed in the longitudinal direction of the vehicle F_{L}, the rear axle assembly 5 may be followed first by the drive gear 4, then the drive unit 3, then the front axle assembly 6 and finally the front attachment assembly 7. The drive unit 3 may comprise an internal combustion engine, such as with at least six cylinders in an in-line design (in-line six-cylinder), and may comprise an engine block 8 and an oil pan 9 arranged or positioned below the engine block 8. Equally, however, the drive unit 3 may also be based on a different technology. The drive gear 4 may be formed by a drive gear housing 10 with drive gear components 46 arranged or positioned therein such as flywheel masses, clutches, shafts, gear wheels or the like, and may be designed as a continuously variable transmission (CVT) or as a powershift transmission. The drive unit 3 may comprise a drive unit output shaft 44 which may be coupled to a drive gear input shaft 45 of the drive gear 4, in particular with the interposition of a clutch 43. See FIG. 6 illustrating the connection between the drive unit and the drive gear. The drive unit output shaft 44 may be arranged or positioned flush with the drive gear input shaft 45 of the drive gear 4; the drive unit output shaft 44 may therefore be arranged or positioned coaxially to the drive gear input shaft 45 of the drive gear 4, wherein deviations may be permissible within the scope of customary tolerances. The rear axle assembly 5 may be formed by at least one rear axle housing 11 with axle and drive components 50 arranged or positioned therein, whereby it may be possible to drive rear ground engagement means 12 arranged or positioned on the rear axle assembly 5 via power provided by the drive unit 3. In addition to a pure drive of the rear ground engagement means 12, it also contemplated to provide additional steering gear components 51 in the rear axle housing 11 so that the rear ground engagement means 12 may also be steered. The rear axle assembly 5 may also include a rear power take-off shaft 52 for driving attachments that may be coupled. See FIG. 8 illustrating a block diagram of the rear axle assembly 5. The front axle assembly 6 may comprise an axle drive housing 13 as well as two wheel suspensions 14 mounted opposite each other on the axle drive housing 13, on which front ground engagement means 15 may be arranged or positioned. In one or some embodiments, the tractor 1, such as shown in FIG. 1, may include the front ground engagement means 15 and the rear ground engagement means 12 that are designed in the form of wheels (e.g., as front wheels and rear wheels, such as a 4 wheel design or an 8 wheel design). However, it is also contemplated that the front ground engagement means 15 and/or the rear ground engagement means 12 may be designed as tracks, such as caterpillar tracks or crawler-type tracks. Various types of tracks are contemplated, such as steel plates as tracks, rubber tracks, or steel-reinforced rubber tracks. In this regard, the front ground engagement means 15 and the rear ground engagement means 12 may comprise a wheeled system or a track system, and may comprise structure that propels or pushes the tractor 1 forward or that pulls the tractor 1 forward.

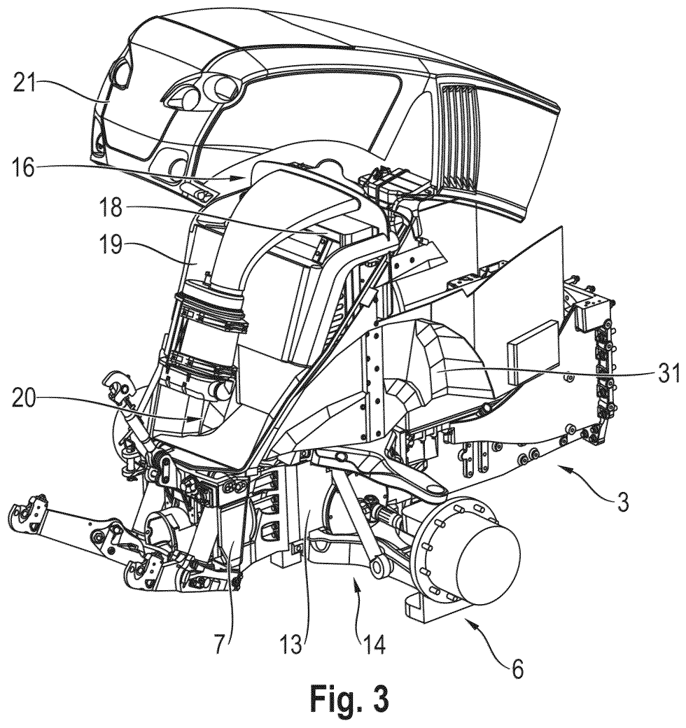

In addition to the chassis 2, the tractor 1 may also comprise a cooling system 16 for cooling the drive unit 3, which is further illustrated in FIG. 3. The cooling system 16 may comprise various units that perform various functions to ensure the cooling circuit of the drive unit 3. In particular, the cooling system 15 may comprise at least one (or only one) fan 17, at least one (or only one) oil cooler 18, and at least one, or only one) heat exchanger 19, which may be arranged or positioned adjacent to one another viewed in the longitudinal direction of the vehicle F_{L}. In FIG. 3, the fan 17 may be concealed by the oil cooler 18 and the heat exchanger 19, whereas in FIG. 2, the fan 17 is shown, but the other components are omitted for reasons of illustration. The position of the fan 17, the oil cooler 18, and/or the heat exchanger 19 in relation to other of the fan 17, the oil cooler 18, and/or the heat exchanger 19 may vary. For example, first the fan 17, then the oil cooler 18 and then the heat exchanger 19 may be arranged or positioned one behind the other starting from the drive unit 3 viewed in the vehicle longitudinal direction F_{L} towards the front of the tractor 1. Similarly, however, first the oil cooler 18, then the heat exchanger 19 and then the fan 17 may also be arranged or positioned one after the other from the drive unit 3 in the direction of the front of the tractor 1. In this regard, the fan 17, the oil cooler 18, and/or the heat exchanger 19 may be order in one of several ways. The various units of the fan 17, the oil cooler 18, and/or the heat exchanger 19 of the cooling system 16 may each be designed as a single part or multipart. The oil cooler 18 and/or the heat exchanger 19 may, for example, be formed by two or more partial oil coolers or two or more partial heat exchangers. In addition to the aforementioned units, fan 17, oil cooler 18 and heat exchanger 19, other units may also be part of the cooling system 16, such as an additional fan. With such a design, the cooling system 16 may be constructed in such a way that, viewed in the longitudinal direction of the vehicle F_{L}, starting from the drive unit 3 in the direction of the front of the tractor 1, first the fan 17, then the oil cooler 18, then the heat exchanger 19 and then the additional fan are arranged or positioned. At least one, any two, or all three of the units, fan 17, oil cooler 18 and heat exchanger 19, may be arranged or positioned inclined in relation to the vehicle longitudinal direction F_{L} and the vehicle height direction F_{H}. The cooling system 16, parts of the drive unit 3, exhaust system components as well as other auxiliary units associated with the drive unit 3, such as pumps, alternators or the like, may be arranged or positioned in an engine compartment 20 of the tractor 1, which may be enclosed by a hood 21. In addition to the chassis 2 and the cooling system 16, the tractor 1 may also comprise a cab 22 in which an operator may be present to control and operate the tractor 1.

In one or some embodiments, the following may be for high maneuverability of the tractor 1 and therefore reliable use thereof, in particular when working in row crops that require high precision: the axle drive housing 13 of the front axle assembly 6 may be arranged or positioned between the drive unit 3 and the front attachment assembly 7 viewed in the longitudinal direction of the vehicle F_{L}. In other words, the axle drive housing 13, and therefore the front axle assembly 6 as a whole, may be arranged or positioned neither completely nor partially below or above the drive unit 3 or the front attachment assembly 7, as is the case with the architecture known from the prior art. Rather, the front axle assembly 6 may adjoin the drive unit 3 on the front or end face viewed in the longitudinal direction of the vehicle F_{L}. The front attachment assembly 7 may in turn be connected to the front axle assembly 6 at the front or front end. Alternatively, or in addition, the cooling system 16 may also be arranged or positioned above the axle drive housing 13 and, viewed in the longitudinal direction of the vehicle F_{L}, completely between a front, vertically extending plane 23 which may be tangent to the envelope curves 24 of the front ground engagement means 15 in the straight-ahead position, and a rear, vertically extending plane 25, which may be tangent to the envelope curves 24 of the front ground engagement means 15 in the straight-ahead position. In other words, the two planes 23, 25 (e.g., the front, vertically extending plane 23 and the rear, vertically extending plane 25) may define an area 26 viewed in the vehicle longitudinal direction F_{L}, in which the cooling system 16 is at least partly or completely/entirely arranged or positioned therein (e.g., all units of the cooling system 16). Both planes 23, 25 may be spanned by the vehicle width direction F_{B} and the vehicle height direction F_{H}. In an embodiment of the tractor 1 with front wheels as front ground engagement means 15, the two planes 23, 25 may have a distance to each other in the vehicle longitudinal direction F_{L}, which may correspond to the diameter of the front wheels. In other words, the point at which the front plane 23 is tangent to the envelope curve 24 of a front wheel in the straight-ahead position is spaced from the point at which the rear plane 25 is tangent to the envelope curve 24 of the same front wheel in the straight-ahead position by the dimension of the diameter of the front wheel. The arrangement of the cooling system 16 in the area 26 defined by the two planes 23, 25 may ensure that the cooling system 16 does not adversely affect the radius of action of the front ground engagement means 15 so that large steering angles of the front ground engagement means 15 may be realized, which may ensure high maneuverability of the tractor 1.

In addition to the specific position of the cooling system, the auxiliary units associated with the drive unit 3 such as pumps, alternators or the like may be arranged or positioned such that they have no detrimental influence on the radius of action of the front ground engagement means 15. In particular, the auxiliary units of the drive unit 3, if such a configuration is provided, may be arranged or positioned completely above an upper, horizontally extending plane 53, which may be tangent to the envelope curve 24 of the front ground engagement means 15 in the straight-ahead position, viewed in the vehicle height direction F_{H}.

So that any one, any combination, or all of the drive unit 3, drive gear 4, rear axle assembly 5, front axle assembly 6, or front attachment assembly 7 of the chassis 2 may be connected to each other, they each comprise connection interfaces. For example, the axle drive housing 13, the drive unit 3 and the front attachment assembly 7 may each comprise two connection interfaces 27, 28 spaced apart from each other in the vehicle longitudinal direction F_{L}, a front connection interface 27 (e.g., a connection interface which points to the front of the tractor 1) and a rear connection interface 28 (e.g., a connection interface which points to the rear of the tractor 1). The axle drive housing 13 and the drive unit 3 may each be connected to each other by means of one of their two connection interfaces 27, 28. The same may apply to the connection between the axle drive housing 13 and the front attachment assembly 7. The axle drive housing 13 and the front attachment assembly 7 of the chassis 2 may also be connected to each other via one of their connection interfaces 27, 28. The drive unit 3 may furthermore be connected to the drive gear 4 via one of its connection interfaces 27, 28, and the front attachment assembly 7 may be configured to couple attachments or to hold ballast weights by means of one of its connection interfaces 27, 28. Configured for coupling attachments or for holding ballast weights means herein that the corresponding connection interface 27, 28 may be designed as an attachment device 29, for example as a three-point power lift or the like. The other components (e.g., drive gear 4 and rear axle assembly 5) may also comprise corresponding connection interfaces, which however will not be discussed in more detail below.

More precisely, the rear connection interface 28.1 of the axle drive housing 13 may be connected to the front connection interface 27.2 of the drive unit 3. The front connection interface 27.1 of the axle drive housing 13 may be connected to the rear connection interface 28.3 of the front attachment assembly 7. The drive unit 3 may also be connected to the drive gear 4 via its rear connection interface 28.2, and the front attachment assembly 7 may be configured to couple attachments or to accommodate ballast weights by means of its front connection interface 27.3. The connection or securing of the various mentioned components of the chassis 2 (e.g., drive unit 3, drive gear 4, axle drive housing 13 or front axle assembly 6 and front attachment assembly 7) with or to each other via the connection interfaces 27, 28, may be achieved by means of suitable connecting means, for example screws, bolts, pins or the like.

With regard to the arrangement of the cooling system 16 in view of the high maneuverability of the tractor 1, in one or some embodiments, the cooling system 16 is not only arranged or positioned completely between the planes 23, 25 (e.g., in the area 26 viewed in the longitudinal direction of the vehicle F_{L}), but rather completely between the two connection interfaces 27, 28 of the axle drive housing 13 (e.g., the front connection interface 27.1 and the rear connection interface 28.1 of the axle drive housing 13). This may fix the position of the cooling system 16 to an area directly above the front axle assembly 6, more precisely directly above the axle drive housing 13.

In order to further improve the maneuverability of the tractor 1, the drive unit 3 may be provided with one or more recesses or indentations, such as a recess 30.1 in an area in front of the connection interface by means of which the drive unit 3 is connected to the axle drive housing 13 (e.g., the front-side connection interface 27.2 of the drive unit 3). In one embodiment in which the drive unit 3 comprises an internal combustion engine, the recess 30.1 may therefore be formed by the housing of the oil pan 9, which may also comprise or form the front and rear connection interface 27.2, 28.2 of the drive unit 3. The front attachment assembly 7 may also have one or more recesses or indentations, such as a recess 30.2. This recess 30.2 may be formed in an area downstream from its connection interface, by means of which the front attachment assembly 7 may be connected to the axle drive housing 13 (e.g., the rear connection interface 28.3 of the front attachment assembly 7). Using one or both of these two recesses 30.1, 30.2 on the drive unit 3 or on the front attachment assembly 7, it is possible to realize a larger steering angle of the front ground engagement means 15. While turning, the front ground engagement means 15 may move into one of the recesses 30.1, 30.2, which may be formed on both sides of the drive unit 3 and the front attachment assembly 7 (e.g., are provided for the front ground engagement means 15 arranged or positioned on both wheel suspensions 14 of the front axle assembly 6). The creation of such recesses 30.1, 30.2 in combination with the positioning of the cooling system 16 relative to the front ground engagement means 15 or the axle drive housing 13 may ensure high maneuverability. The hood 21 may also comprise correspondingly formed or shaped one or more recesses or indentations, such as recesses 31 above the recesses 30.1, 30.2 so as not to adversely affect the radius of action of the front ground engagement means 15.

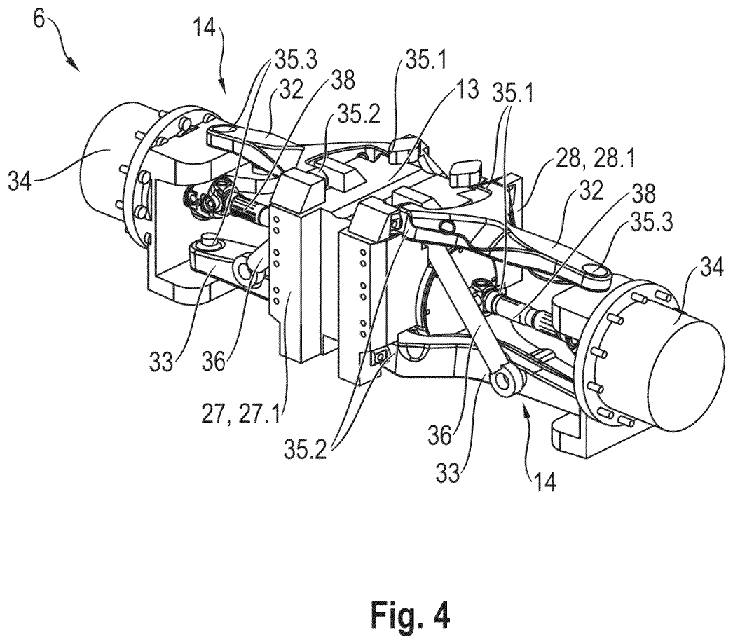

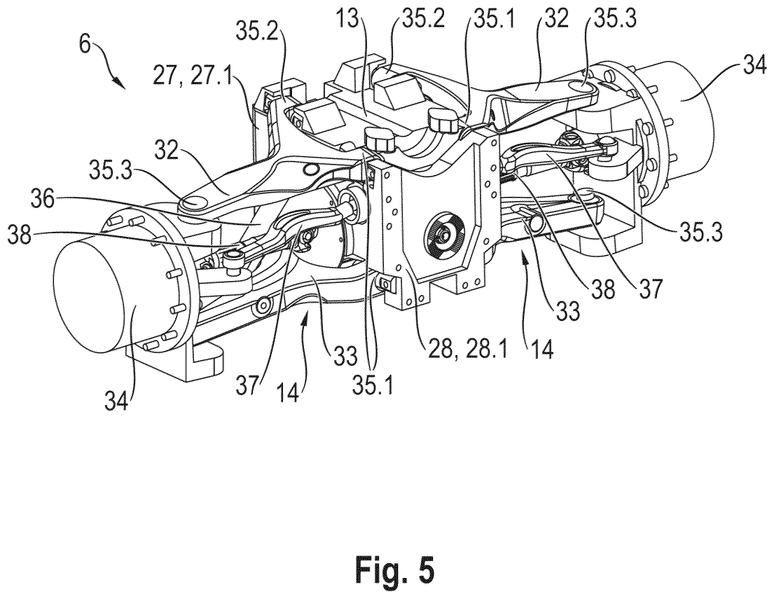

In one or some embodiments, each of the wheel suspensions 14 arranged or positioned or mounted on the axle drive housing 13 may be characterized by a multi-part structure, which in particular is shown in more detail in FIGS. 4 and 5. The wheel suspensions 14 each may comprise an upper wishbone 32 and a lower wishbone 33. The upper wishbone 32 and the lower wishbone 33 may each be pivotably connected or mounted, on the one hand, to or on the axle drive housing 13 and, on the other hand, to a wheel hub 34, on which at least one front ground engagement means 15 is rotatably mounted in each case. Either only one front ground engagement means 15 or also two front ground engagement means 15 spaced apart from each other in the vehicle width direction F_{B} (a so-called double tire, which may be used in particular when working in row crops) may be arranged or positioned on the wheel hub 34 of each wheel suspension 14. The upper wishbone 32 and the lower wishbone 33 of a wheel suspension 14 may each extend away from the tractor 1 in the vehicle width direction F_{B} starting from the axle drive housing 13 and may be spaced apart from each other in the vehicle height direction F_{H}. The upper wishbone 32 and/or the lower wishbone 33 of a wheel suspension 14 may be designed Y-shaped, wherein each Y-shaped wishbone 32, 33 may be pivotably connected to the axle drive housing 13 by means of two connection points 35.1, 35.2, such as about a bolt of the axle drive housing 13, and rotatably connected to the wheel hub 34 by means of a connection point 35.3, such as via a ball head formed on the wheel hub 34. In one or some embodiments, as also shown in the figures, both the upper wishbone 32 and the lower wishbone 33 of each wheel suspension 14 are each Y-shaped. In addition to the Y-shaped design of the wishbones 32, 33, the external geometry of the wishbones 32, 33 may be selected such that the steering angle of the front ground engagement means 15 may be further increased (e.g., the maneuverability of the tractor 1 is further increased). Such a geometric design may be achieved, for example, via folded edges, recesses or the like. The upper wishbone 32 and/or the lower wishbone 33 may also be coupled to the axle drive housing 13 by means of at least one suspension and/or damping element 36, for example a suspension cylinder. The radius of action of the front ground engagement means 15 provided by the wheel suspensions 14 and the suspension and/or damping element 36 may be selected, taking into account the structural design of the chassis 2 and the arrangement of the cooling system 16, such that the front ground engagement means 15 do not come into contact with other components, assemblies or the like of the tractor 1 at any time.

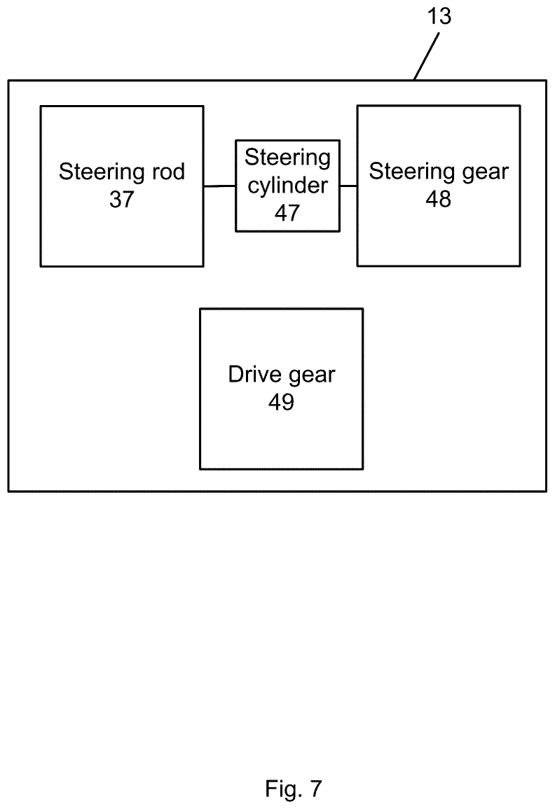

Each wheel suspension 14 of the front axle assembly 6 may further comprise a steering rod 37, which may be coupled on the one hand to the wheel hub 34 and on the other hand to a steering gear 48 arranged or positioned in the axle drive housing 13. The steering rod 37 and the steering gear 48 may be coupled with the interposition of a steering cylinder 47. See FIG. 7 illustrating an expanded block diagram of the axle drive housing 13. The steering rod 37 may be positioned, viewed in the longitudinal direction of the vehicle F_{L}, closer to the connection interface of the axle drive housing 13, through which the axle drive housing 13 may be connected to the drive unit 3 (e.g., the rear connection interface 28.1 of the axle drive housing 13) than at the connection interface of the axle drive housing 13 through which the axle drive housing 13 is connected to the front attachment assembly 7 (e.g., the front-side connection interface 27.1). In one or some embodiments, viewed in the vehicle longitudinal direction F_{L}, the steering rod 37 is arranged or positioned behind an axle (not shown in the figures) extending centrally through the wheel hubs 34 of the wheel suspension 14 in the vehicle width direction F_{B}. In other words, the steering rod 37, viewed in the vehicle longitudinal direction F_{L}, may lie between the connection interface of the axle drive housing 13, through which the axle drive housing 13 is connected to the drive unit 3 (e.g., the rear connection interface 28.1 of the axle drive housing 13 and the axle running centrally through the wheel hubs 34). In addition to the steering gear 48, a drive gear 49 may also be arranged or positioned in the axle drive housing 13. If such a drive gear 49 is provided, the drive unit 3 may comprise a drive unit output shaft 44. The drive gear 49 may then be coupled to the drive unit output shaft 44, in particular with the interposition of a clutch, whereby the front ground engagement means 15 are not only steerable but also drivable. In such a design, the coupling of the wheel hub 34 and drive gear 49 may be realized via a drive shaft 38, which may extend in the vehicle width direction F_{B} from the axle drive housing 13 or from the drive gear 49 arranged or positioned therein to the wheel hub 34. The axle running centrally through the wheel hubs 34 in the vehicle width direction F_{B} may also form the axis of rotation of the drive shaft 38 in such a design. By using a drive gear in the front axle assembly 6, it may be possible to realize various driving modes such as a pure rear-wheel drive, a pure ground engaging drive, or an all-wheel drive.

The drive unit 3 may comprise a further output shaft 39. This further output shaft 39 may be coupled to a front power take-off shaft 40 mounted in the front attachment assembly 7, such as with the interposition of a power take-off shaft gearbox 41 arranged or positioned in the front attachment assembly 7, in particular with a clutch, as well as a shaft 42, such as cardan shaft, for bridging the axle drive housing 13. The front PTO shaft 40 may serve to supply attachments coupled to the tractor 1 by means of the attachment device 29 with power provided by the drive unit 3. The power take-off shaft 40, the power take-off shaft gearbox 41 arranged or positioned in the front attachment assembly 7 and/or the attachment device 29 for coupling attachments or for holding ballast weights may be located in front of the front, vertically extending plane 23 viewed in the vehicle longitudinal direction F_{L}, which may be tangent to the envelope curve 24 of the front ground engagement means 15 in the straight-ahead position so that this does not create any disadvantageous restrictions with regard to the steering angle of the front ground engagement means 15 and therefore the maneuverability of the tractor 1. In one or some embodiments, the power take-off shaft 40, the power take-off shaft gearbox 41 arranged or positioned in the front attachment assembly 7 and the attachment device 29 for coupling attachments or for holding ballast weights may all be arranged or positioned in front of the front, vertically extending plane 23, which may be tangent to the envelope curve 24 of the front ground engagement means 15 in the straight-ahead position viewed in the vehicle longitudinal direction F_{L}.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Tractor
2 Chassis
3 Drive unit
4 Drive gear
5 Rear axle assembly
6 Front axle assembly
7 Front attachment assembly
8 Engine block
9 Oil pan
10 Drive gear housing
11 Rear axle housing
12 Rear ground engagement means
13 Axle drive housing
14 Wheel suspension
15 Front ground engagement means
16 Cooling system
17 Fan
18 Oil cooler
19 Heat exchanger
20 Engine compartment
21 Hood
22 Cab
23 Front plane
24 Envelope curve of front ground engagement means
25 Rear plane
26 Area between planes
27 Front connection interface
27.1 Front connection interface of axle drive housing
27.2 Front connection interface of drive unit
27.3 Front connection interface of front attachment assembly
28 R connection interface
28.1 Rear connection interface of axle drive housing
28.2 Rear connection interface of drive unit
28.3 Rear connection interface of front attachment assembly
29 Attachment device
30.1 Drive unit recess
30.2 Front attachment assembly recess
31 Hood recess
32 Upper wishbone
33 Lower wishbone
34 Wheel hub
35.1 Axle drive housing connecting point
35.2 Axle drive housing connecting point
35.3 Wheel hub connecting point
36 Suspension and/or damping element
37 Steering rod
38 Driveshaft
39 Drive unit output shaft
40 Front PTO shaft
41 Power take-off shaft gearbox
42 Shaft
43 Clutch
44 Drive unit output shaft
45 Drive gear input shaft
46 Drive gear components
47 Steering cylinder
48 Steering gear
49 Drive gear
50 Axle and drive components
51 Steering gear components
52 Rear power take-off shaft
53 Upper, horizontally extending plane
F_{L} Vehicle longitudinal direction
F_{B} Vehicle width direction
F_{H} Vehicle height direction

1. A tractor comprising:
a chassis, wherein the chassis comprises a drive unit, a drive gear, a drivable rear axle assembly with rear ground engagement means positioned thereon;
a front axle assembly with front ground engagement means positioned thereon;
a front attachment assembly configured to couple one or more attachments or to receive ballast weights, wherein the front axle assembly comprises an axle drive housing and two wheel suspensions mounted opposite one another on the axle drive housing, on which the front ground engagement means are positioned, wherein the axle drive housing of the front axle assembly is positioned between the drive unit and the front attachment assembly as viewed in a longitudinal direction of the tractor; and
a cooling system configured to cool the drive unit, wherein the cooling system is positioned above the axle drive housing and, viewed in a longitudinal direction of the tractor, is located entirely between a front, vertically extending plane, which is tangent to one or more envelope curves of the front ground engagement means in the straight-ahead position, and a rear, vertically extending plane which is tangent to the one or more envelope curves of the front ground engagement means in the straight-ahead position.

2. The tractor of claim 1, wherein the axle drive housing, the drive unit and the front attachment assembly each comprise at least two connection interfaces spaced apart from one another in the vehicle longitudinal direction;
wherein the axle drive housing and the drive unit are each connected to one another via one of their at least two connection interfaces;
wherein the axle drive housing and the front attachment assembly are each connected to one another via one of their at least two connection interfaces;
wherein the drive assembly is connected to the drive gear via one of its at least two connection interfaces; and
wherein the front attachment assembly is configured for coupling attachments or for holding ballast weights via one of its at least two connection interfaces.

3. The tractor of claim 2, wherein the cooling system, viewed in the longitudinal direction of the tractor, is positioned completely between the at least two connection interfaces of the axle drive housing.

4. The tractor of claim 2, wherein the drive unit is connected to the axel drive housing in a region upstream from the connection interface of the drive unit;
wherein the front attachment assembly is connected to the axel drive housing in a region after the connection interface of the front attachment assembly;
wherein at least one of the drive unit or the front attachment assembly has a respective recess; and
wherein, at least partly while the tractor is turning, the front ground engagement means 15 is configured to move into the respective recess of the at least one of the drive unit or the front attachment assembly for additional maneuverability.

5. The tractor of claim 4, wherein each of the drive unit and the front attachment assembly has a respective recess; and
wherein, at least partly while the tractor is turning, the front ground engagement means is configured to move into the respective recess of each of the drive unit and the front attachment assembly for additional maneuverability.

6. The tractor of claim 4, wherein the drive unit comprises an internal combustion engine with an engine block and an oil pan positioned below the engine block; and
wherein the respective recess of the drive unit is formed by housing of the oil pan; and
wherein the respective recess of the drive unit is configured to form a front connection interface and a rear connection interface of the drive unit.

7. The tractor of claim 1, wherein the two wheel suspensions of the front axle assembly comprises an upper wishbone and a lower wishbone, which are each pivotably connected to the axle drive housing and to a wheel hub, on each of which at least a part of the front ground engagement means is rotatably mounted.

8. The tractor of claim 7, wherein the two wheel suspensions of the front axle assembly comprise a steering rod which is coupled to the wheel hub and to a steering gear positioned in the axle drive housing.

9. The tractor of claim 8, wherein the two wheel suspensions are each coupled to the steering gear via a steering cylinder.

10. The tractor of claim 8, wherein, viewed in the vehicle longitudinal direction, the steering rod is positioned closer to the connection interface of the axle drive housing, through which the axle drive housing is connected to the drive unit, than to the connection interface of the axle drive housing, through which the axle drive housing is connected to the front attachment assembly.

11. The tractor of claim 8, wherein the steering rod, viewed in a vehicle width direction, is positioned behind an axle extending centrally through wheel hubs of the two wheel suspensions.

12. The tractor of claim 7, wherein at least one of the upper wishbone or the lower wishbone of the two wheel suspensions of the front axle assembly is coupled to the axle drive housing through one or both of at least one suspension or a damping element.

13. The tractor of claim 7, wherein at least one of the upper wishbone or the lower wishbone of the two wheel suspensions of the front axle assembly is Y-shaped; and
wherein the at least one of the upper wishbone or the lower wishbone is pivotably connected to the axle drive housing via at least two connection points and rotatably connected to at least one wheel hub via another connection point.

14. The tractor of claim 1, wherein the drive unit comprises an output shaft;
wherein the output shaft is configured for coupling to an input shaft of the drive gear, via a clutch, and is aligned therewith.

15. The tractor of claim 1, wherein the drive unit comprises an output shaft;
wherein the output shaft is configured for coupling, via a power take-off shaft gearbox positioned in the front attachment assembly and a shaft, to a power take-off shaft mounted in the front attachment assembly; and
wherein the power take-off shaft, viewed in the longitudinal direction of the tractor, is positioned completely in front of the front, vertically extending plane which is tangent to the one or more envelope curves of the front ground engagement means in a straight-ahead position.

16. The tractor of claim 1, wherein the drive unit comprises an output shaft; and
wherein the output shaft is configured for coupling to a drive gear positioned in the axle drive housing for driving the front ground engagement means.

17. The tractor of claim 1, wherein one or more auxiliary units are assigned to the drive unit;
wherein the one or more auxiliary units, viewed in a vehicle height direction, are positioned completely above an upper, horizontally extending plane which is tangent to the one or more envelope curves of the front ground engagement means in a straight-ahead position.

18. The tractor of claim 1, wherein the cooling system comprises at least one fan, at least one oil cooler, and at least one heat exchanger that are positioned adjacent to each other viewed in the longitudinal direction of the tractor.

19. The tractor of claim 18, wherein at least one of the at least one fan, the at least one oil cooler, or the at least one heat exchanger of the cooling system is positioned inclined with respect to the vehicle longitudinal direction and the vehicle height direction.
